(19) United States
(12) Patent Application Publication
(10) Pub. No.: US 2022/0091434 A1
(43) Pub. Date: Mar. 24, 2022

(54) CONNECTION ELEMENT FOR CONNECTING TWO PARTS OF EYEGLASSES AND PROCESS FOR CONNECTING TWO PARTS OF EYEGLASSES BY MEANS OF SAID CONNECTION ELEMENT

(71) Applicant: VISOTTICA INDUSTRIE S.p.A., Susegana (IT)

(72) Inventor: Rinaldo MONTALBAN, Venezia (IT)

(21) Appl. No.: 17/478,988

(22) Filed: Sep. 20, 2021

(30) Foreign Application Priority Data
Sep. 24, 2020 (IT) 102020000022552

(51) Int. Cl. G02C 5/14; G02C 1/08

(52) U.S. Cl. CPC G02C 5/146; G02C 1/08

(57) ABSTRACT

Connection element for connecting two parts of eyeglasses, comprising a first body provided with a through hole, a second body provided with a threaded hole, and a connection screw inserted in the through hole and screwed in the threaded hole in order to fix together the two bodies. The through hole of the first body comprises an internal chamber made as an undercut and housing the head of the connection screw. The connection screw is movable between an alignment position, in which its head is aligned with the edge of the through hole of the first body in order to allow the passage of the head, and a misalignment position, in which the head of the connection screw and the edge of the through hole are angularly offset in order to prevent the head of the connection screw from exiting from the internal chamber of the through hole.

### FIELD OF APPLICATION

The present invention regards a connection element for connecting two parts of eyeglasses and a process for connecting two parts of eyeglasses by means of said connection element.

The present connection element is advantageously intended to be employed in the production of eyeglasses, in particular in order to fix together two ends of a rim of a frame in order to retain a lens housed within the rim itself.

Therefore, the present connection element and connection process fall within the industrial field of the eyeglasses, i.e. the production of eyeglasses and accessories and components for eyeglasses.

### STATE OF THE ART

As is known, eyeglasses are formed by multiple parts that are mechanically connected to each other by means of connection elements. In particular, eyeglasses generally comprise a frame formed by a pair of temples connected, by means of corresponding hinges, to a front. The latter comprises a bridge that connects to a pair of rims, in which corresponding lenses of the eyeglasses are housed.

The rims of the frame can be of non-openable type, i.e. continuously formed, employed in frames made with deformable materials (e.g. acetate frames), which allow assembling the lenses due to the elastic deformation of the material.

Also known are rims of openable type, employed in frames made with material that are poorly deformable (e.g. metallic frames or frames made of horn). The rims of the latter type are cut at two ends, which are spaced during the step of inserting and/or disassembly of the lens, and subsequently approached in order to be fixed and stably retain the lens within the rim.

The fixing of the two ends of the rim is generally attained by means of a connection element termed “rim-lock tube” or “rim lock” in the jargon of the field.

The connection elements of known type comprise a first and a second body, with tubular shape, fixed by means of welding to the corresponding ends of the rim of the eyeglasses and tightened together by means of a connection screw so as to retain the ends of the rim itself adjacent.

More in detail, the first body is provided with a through hole, and the second body is provided with a threaded hole. The connection screw comprises a stem, which is inserted in the through hole of the first body and is screwed by means of a threaded portion thereof to the threaded hole of the second body, and a head, which acts in abutment against the first body in order to maintain it constrained to the second body. More particularly, the through hole of the first body of the connection element is provided with a widened section arranged for housing the head of the screw.

Several examples of connection elements of the type briefly mentioned above are described in the patent documents US 2006/0164594, U.S. Pat. Nos. 5,387,102 and 4,813,775.

Normally, the connection element is supplied to the eyeglasses producer in the form of a semifinished body formed by the two aforesaid bodies still joined in a single body, with a partially threaded through opening which defines the two holes of the (future) bodies.

In operation, in order to assemble the connection element to the eyeglasses, the semifinished body is fixed, for example via welding, to the rim of the front, which is subsequently cut at the point where the semifinished body itself is fixed, in a manner such to obtain the two ends separate of the rim with the corresponding bodies of the connection element fixed thereto.

Subsequently, the connection screw is applied in order to tighten together the bodies of the connection element and then close the rim of the front.

The above-described connection elements of known type have in practice demonstrated that they do not lack drawbacks.

A first drawback lies in the fact that the operations of assembly of substitution of the lenses are relatively inconvenient, since the connection screw can easily exit outward from the holes of the bodies of the connection element and be lost. Indeed, when the connection screw is unscrewed from the threaded hole of the second body in order to open the rim of the front, this can be easily extracted from the bodies and fall. Such risk is accentuated by the fact that the connection elements are oriented with the head of the screw directed downward during the normal use of the eyeglasses. The aforesaid positioning derives mainly for aesthetic needs, since it allows the head of the screw hiding from sight (during the normal use of the eyeglasses).

In addition, the connection screws of the connection elements have very limited dimensions, and a fall to the ground thereof makes it hard to identify them with the human eye, with consequent loss of the component, rendering necessary the substitution thereof, with increase of costs and time for the final user.

In order to at least partly resolve such technical problems, a connection element is known, in particular described in the document U.S. Pat. No. 4,904,077, in which the stem of the connection screw is provided with a thinned portion placed next to the head of the screw itself. In particular, such thinned portion of the stem is extended in a tapered manner towards the head, and the bottom face of the latter has substantially frustoconical section in a manner such to delimit, with the thinned portion of the stem, a circumferential recess defining an acute angle at the junction point between the stem and the head of the connection screw. In addition, the first body of the connection element is provided, within its through hole, with an annular shoulder which receives in abutment the bottom face of the head of the connection screw when the latter is engaged with the bodies of the connection element. In particular, following the screwing of the connection screw with the threaded hole of the second body, the bottom surface of the head of the screw deforms the shoulder of the first body, making it penetrate into the recess of the stem. In this manner, the deformed shoulder of the first body defines a narrowing of the through hole with diameter smaller than that of the stem (outside the thinned portion) which prevents the stem itself from being extracted from the through hole even when it is extracted from the threaded hole of the second body, hence preventing the connection screw from being separated from the first body. In particular, in case of unscrewing of the connection screw, the widened stem portion interferes with the narrowing determined by the deformed shoulder, obstructing the exit of the connection screw.

Also the latter connection element of known type has in practice shown that it does not lack drawbacks.

The main drawback lies in the fact that such connection element of known type cannot be easily disassembled, if not by operating a new deformation of the shoulder of the first body, in order to bring it back to the original position. However, such deformation is difficult and risks compromising the reuse of the connection element. In addition, following the unscrewing of the connection screw, it is commonly possible that the shoulder tends to be rewidened, allowing the extracting of the screw and, therefore, the above-described connection element does not allow reliably resolving the problem of preventing accidental falls of the screw once the connection element is disassembled.

### PRESENTATION OF THE INVENTION

In this situation, the problem underlying the present invention is to eliminate the drawbacks of the abovementioned prior art, by providing a connection element for connecting two parts of eyeglasses and a process for connecting two parts of eyeglasses which facilitate the operations of assembly and substitution of the lenses, in particular allowing the prevention, in a reliable manner, of the exit and loss of the screw following the unscrewing of the same.

A further object of the present invention is to provide a connection element for connecting two parts of eyeglasses which allows mounting and disassembling such connection element without having to completely remove the connection screw.

A further object of the present invention is to provide a connection element for connecting two parts of eyeglasses which can be easily handled, also manually.

A further object of the present invention is to provide a connection element for connecting two parts of eyeglasses which is entirely reliable during its use.

A further object of the present invention is to provide a process for connecting two parts of eyeglasses which is simple, quick and inexpensive to achieve.

### BRIEF DESCRIPTION OF THE DRAWINGS

The technical characteristics of the invention, according to the aforesaid objects and the advantages of the same will be more evident from the following detailed description, made with reference to the enclosed drawings, which represent several merely exemplifying and non-limiting embodiments of the invention, in which:

FIG. 1a illustrates eyeglasses provided with the connection element according to the present invention, in accordance with a first embodiment;

FIG. 1b illustrates an eyeglasses portion provided with the connection element according to the present invention, in accordance with a second embodiment;

FIG. 1c illustrates an eyeglasses portion provided with the connection element according to the present invention, in accordance with a third embodiment;

FIG. 2 shows a perspective view of the connection element according to the present invention, in particular fixed to a rim of a frame of the eyeglasses, in which several components are represented in transparent view;

FIG. 3 shows a view from a different perspective of the connection element of FIG. 2;

FIG. 4 shows a side view of the connection element, in which several components are represented in transparent view;

FIGS. 5a, 5b show a perspective view of a first body of the connection element with a connection screw positioned in two different positions;

FIGS. 6a, 6b respectively show a front view of the connection element, and a sectional view of the connection element illustrated in FIG. 6a, attained along the trace VI-VI of FIG. 6a;

FIGS. 7a, 7b respectively show a front view of the connection element, and a sectional view of the connection element illustrated in FIG. 7a, attained along the trace VII-VII of FIG. 7a, in which the connection screw has been removed;

FIG. 8 shows a perspective view of the connection element illustrated in FIG. 7a;

FIG. 9 shows a sectional perspective view of the connection element, made along the trace IX-IX of FIG. 7a;

FIGS. 10a, 10b, 10c respectively show a front view, a perspective view and a top view of the connection screw of the connection element;

FIGS. 11a and 11b show two embodiment variants of the connection screw;

FIG. 12 shows a semifinished body from which the present connection element is obtained, in particular the embodiment of FIGS. 2-9;

FIGS. 13a and 13b show, respectively, a perspective view and a longitudinal sectional view (without the connection screw) of the connection element in accordance with an embodiment variant of the invention;

FIGS. 13c and 13d show, respectively, a perspective view and a longitudinal sectional view of a semifinished body from which the connection element of FIGS. 13a and 13b is obtained;

FIGS. 14a and 14b show several operating steps of the present connection process, in accordance with a first embodiment version;

FIGS. 15a-15c show several operating steps of the present connection process, in accordance with a second embodiment version;

FIGS. 16a-16d show several operating steps of the present connection process relative to the insertion and tightening of the connection screw.

### DETAILED DESCRIPTION OF A PREFERRED EMBODIMENT

With reference to the enclosed drawings, reference number 1 overall indicates the connection element for connecting two parts of eyeglasses, object of the present invention.

The present connection element 1 is intended to be employed for connecting two parts 101, 102 of eyeglasses, in particular of the frame of the latter, for eyeglasses of any type, e.g. conventional or sports type.

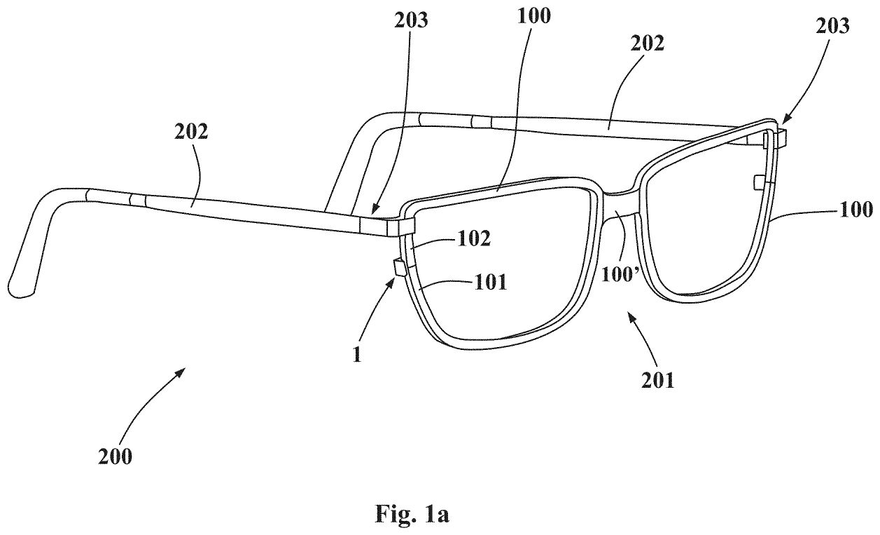

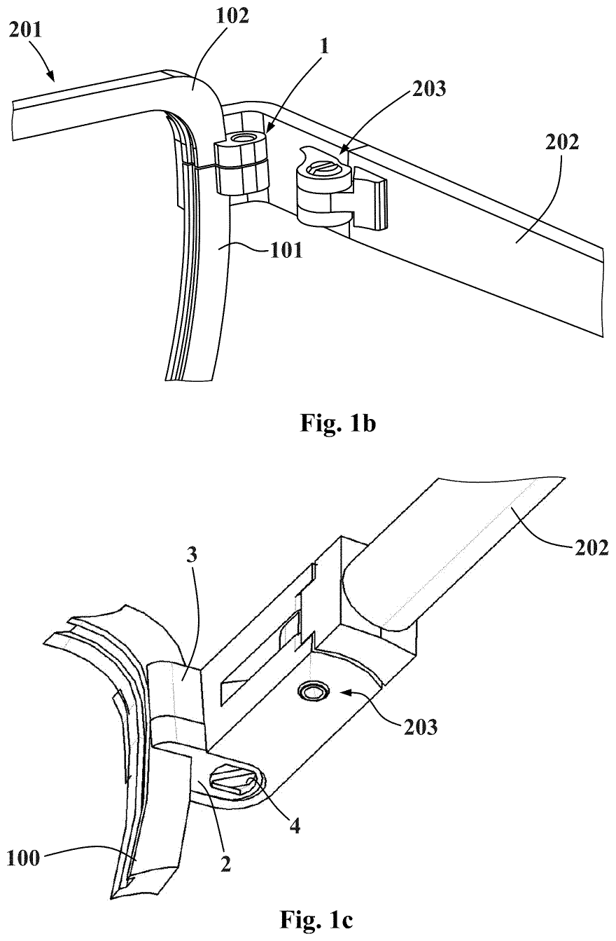

With reference to the examples of FIGS. 1a, 1b and 1c, eyeglasses comprise a frame 200 conventionally provided with a front 201 and with two temples 202 hinged to corresponding sides of the front 201 by means of corresponding hinges 203. The front 201 comprises two rims 100 connected to each other by a bridge 100′ intended to be abutted against the nose of a user. As is known, the rims 100 are intended to house the lenses of the eyeglasses at their interior.

In particular, each rim 100 comprises an annular body (for example made of metallic material) which is provided, along its annular extension, with a cut which defines a first (end) part 101 and a second (end) part 102 of the rim 100 itself.

The connection element 1, object of the invention, comprises a first body 2 intended to be fixed to the first part 101 of the eyeglasses (and in particular of the rim 100), and a second body 3 intended to be fixed to the second part 102 of the eyeglasses (and in particular of the rim 100).

In addition, the connection element comprises a connection screw 4 engaged with the first and second bodies 2, 3 so as to maintain them constrained to each other, as described in detail hereinbelow.

Hereinbelow reference will be made to the preferred solution of the enclosed figures, in which the connection element is placed to mechanically connect two end parts 101, 102 of a rim 100 of the frame 200.

In particular, the connection element 1 retains fixed together, substantially adjacent to each other, the two end parts 101, 102 of the rim 100, in a manner such to close the ring of the latter so as to retain the lens within the rim 100 itself.

In accordance with the aforesaid preferred solution, the first body 2 of the connection element 1 is fixed to the first end part 101 of the rim 100 and the second body 3 is fixed to the second end part 102 of the rim 100 itself.

Of course, the end parts 101, 102 of the rim 100 (and hence the connection element 1) can be substantially arranged along any point of the annular extension of the rim 100 itself.

For example, the connection element 1 can be placed at a point of the rim between the hinge 203 and the nosepiece 100′ (as in the example of FIG. 1a), or at the hinge 203 (as in the example of FIG. 1b).

In particular, with reference to the example of FIG. 1c, one of the bodies 2, 3 of the connection element 1 can be integrated (also in a single body) with one of the articulation elements of the hinge 203.

In accordance with an embodiment variant not illustrated in the enclosed figures, the connection element 1 can be placed to mechanically connect two different parts of eyeglasses, for example to rotatably connect the two articulation elements of a hinge of the eyeglasses (in such case, each body 2, 3 forms at least part of the corresponding articulation element, and the connection screw forms the pivot of the hinge).

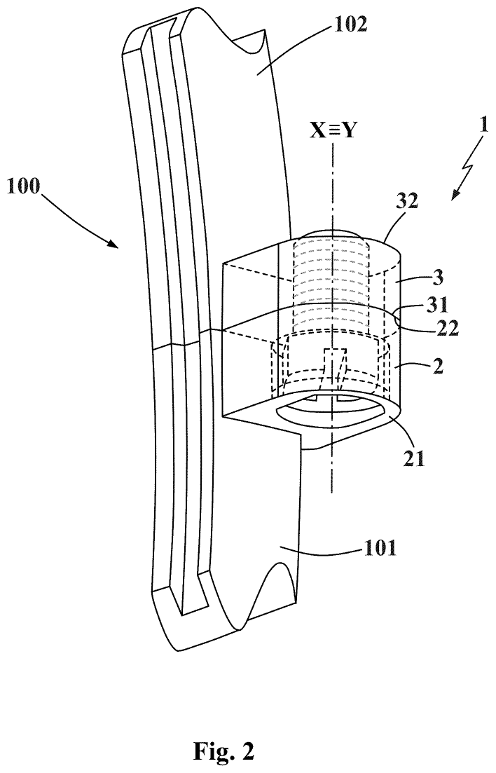

According to the invention, the first body 2 of the connection element 1 is extended along an extension axis X between a first external end 21 and a first internal end 22. In particular, with reference to a preferred embodiment, illustrated in FIG. 2, during use the first external end 21 is intended to be directed downward during the normal use of the eyeglasses, while the second internal end 22 is intended to be directed in the opposite direction (upward).

The first body 2 is also provided with a through hole 23, which is extended between an inlet opening 24 made on the first external end 21 and an outlet opening 25 (preferably circular), which is made on the first internal end 22 and has diameter D smaller than the width of the inlet opening 24.

Advantageously, the body 2 is provided with a first internal surface 23′, which is extended as a ring around the extension axis X and defines the aforesaid through hole 23.

The second body 3 is extended along the aforesaid extension axis X between a second internal end 31, which is directed towards the first internal end 22 of the first body 2, and an opposite second external end 32. In addition, the second body 3 is provided with a threaded hole 33 extended starting from the aforesaid second internal end 31.

Advantageously, the second body 3 is provided with a first opening 310 (from which the threaded hole 33 is extended), placed at the second internal end 31 and substantially facing the outlet opening 25 of the first body 2.

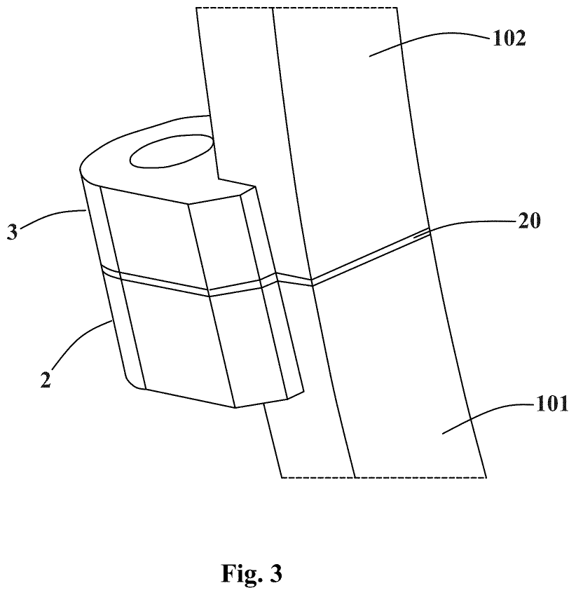

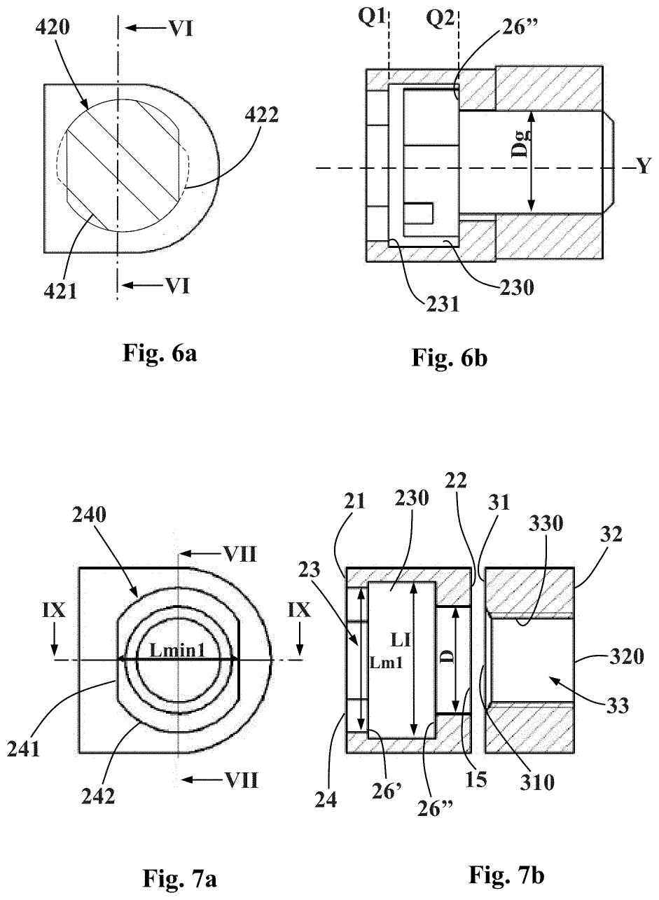

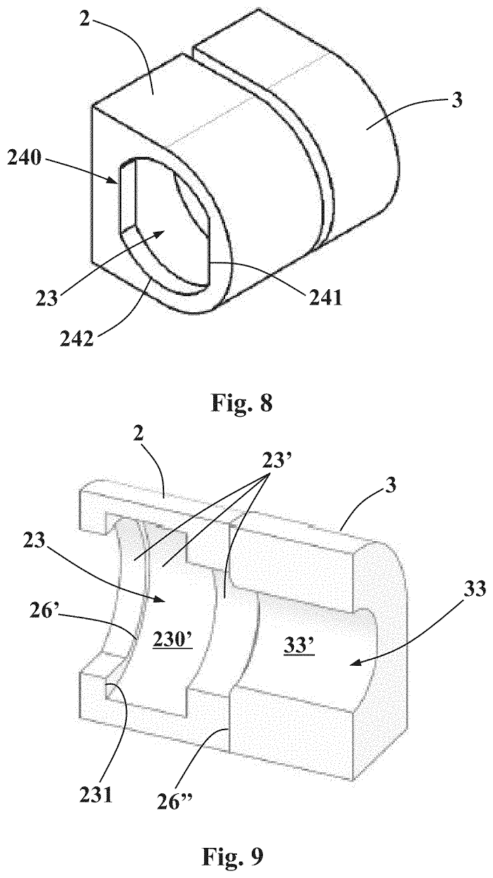

In accordance with a particular embodiment of the invention (illustrated for example in FIGS. 2-9), the threaded hole 33 of the second body 3 is through and is extended between the first opening 310 of the second internal end 31 and a second opening 320 made on the second external end 32.

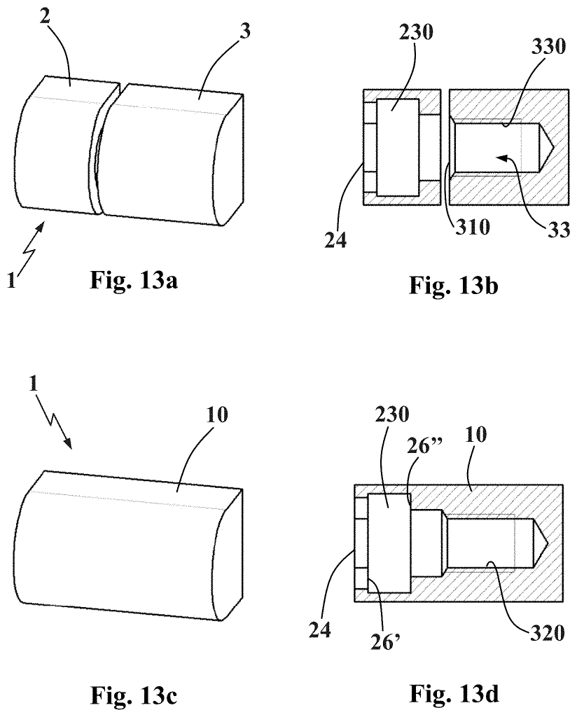

Otherwise, in accordance with an embodiment variant (illustrated for example in FIGS. 13a and 13b), the second body 3 is provided with only the first opening 310, and the threaded hole 33 is blind, for example extended starting from the first opening 310 of the second internal end 31 up to an internal terminal wall of the second body 3. Advantageously, the threaded hole 33 is provided with a thread 330, which is made on a second internal surface 33′ of the second body 3 extended around the extension axis X and defining the threaded hole 33 itself.

In particular, the thread 330 of the threaded hole 33 of the second body 3 can be extended over the entire axial extension of the threaded hole 33, or only for a limited section of the latter sufficient in any case for ensuring the engagement of the connection screw 4.

Advantageously, the first body 2 and the second body 3 have substantially tubular form and/or they are preferably made of metallic material.

The connection screw 4 is inserted, at least partially, in the through hole 23 of the first body 2 and in the threaded hole 33 of the second body 3 in order to mechanically constrain the first body 2 to the second body 3.

In addition, the connection screw 4 comprises a stem 41, which is longitudinally extended along a screwing axis Y (substantially parallel to the extension axis X), is inserted in the through hole 23 and in the threaded hole 33 and is provided with at least one threaded portion 410 engaged via screwing in the threaded hole 33 of the second body 3.

In accordance with the preferred embodiment, the threaded portion 410 of the stem 41 of the connection screw 4 is extended for an extension at least equal to the extension of the thread 330 of the threaded hole 33.

The connection screw 4 also comprises a head 42, which is fixed to the stem 41 and has width greater than the diameter Dg of the stem 41 itself and greater than the diameter D of the outlet opening 25 of the first body 2.

In this manner, the head 42 of the connection screw 4 acts in abutment against the first body 2 in order to maintain the latter constrained to the second body 3.

In accordance with the idea underlying the present invention, the through hole 23 of the first body 2 of the connection element 1 comprises an internal chamber 230, which is placed as a connection between the inlet opening 24 and the outlet opening 25, is extended at least partly as an undercut with respect to the inlet opening 24, and houses the head 42 of the connection screw 4.

According to the invention, the inlet opening 24 is provided with a first shaped edge 240, which defines an opening of the inlet opening 24 susceptible of being traversed by the head 42 of the connection screw 4.

The first shaped edge 240 of the inlet opening 24 is provided with at least one first narrowing section 241, along which the internal chamber 230 is provided with at least one interference shoulder 231 directed towards the first internal end 22 of the first body 2. In particular, such first narrowing section 241 delimits the extension of the interference shoulder 231 towards the center of the inlet opening 24 (i.e. towards the extension axis X).

In particular, the width (cut transverse to the extension axis X) of the inlet opening 24 measured at the aforesaid first narrowing section 241 is smaller than the width measured outside such first narrowing section 241.

The head 42 of the connection screw 4 is also provided with a second shaped edge 420, which is provided with at least one second narrowing section 421.

In particular, the width (cut transverse to the extension axis X) of the head 42 measured at the aforesaid second narrowing section 421 is smaller than the width measured outside such second narrowing section 421.

In addition, the connection screw 4 is movable, and in particular its head 42 within the internal chamber 230, by means of rotation around the screwing axis Y, between at least one alignment position and at least one misalignment position.

In particular, when the connection screw 4 is in the alignment position, the narrowing sections 241 and 421, respectively, of the inlet opening 24 and of the head 42 are in coinciding angular position, in a manner such that the head 42 is capable of passing through the inlet opening 24 of the first body 2. When the connection screw 4 is in misalignment position, the angular positions of the narrowing sections 241 and 421 are offset (they do not coincide), in a manner such that the head 42 of the connection screw 4 is not capable of passing through the inlet opening 24 of the first body 2, remaining within the internal chamber 230.

More in detail, in the alignment position the second narrowing section 421 of the head 42 of the connection screw 4 is angularly aligned with the first narrowing section 241 of the inlet opening 24 of the first body 2 and the second shaped edge 420 of the head 42 of the connection screw 4 is contained within the opening of the inlet opening 24, in order to allow the passage of the head 42 through the inlet opening 24. In the misalignment position the second narrowing section 421 of the head 42 is angular offset with respect to the first narrowing section 241 of the inlet opening 24; in addition, the interference shoulder 231 is interposed between the head 42 and the first external end 21 of the first body 2 and is susceptible to receive in abutment the head 42 of the connection screw 4 in order to prevent the head 42 from exiting from the through hole 23 through the inlet opening 24.

In this manner, it is possible to place the connection screw 4 in the alignment position in order to insert the head 42 in the internal chamber 230 through the inlet opening 24 of the first body 2 and screw the stem 41 in the threaded hole 33 of the second body 3. When it is necessary to unscrew the connection screw 4 from the second body 3 (for example in order to mount the lens in the rim 100 or carry out the removal thereof), the head 42 will be found within the internal chamber 230 in a random (angular) position, which will be very unlikely to coincide with the alignment position and, therefore, quite probably will be found in misalignment position, preventing the head 42 from passing through the inlet opening 24 of the first body 2 and therefore preventing the connection screw 4 from being undesirably extracted from the latter.

The configuration of the present invention, therefore, efficiently prevents the connection screw 4, when it is unscrewed, from falling or being lost, in particular allowing the execution in a safe and simple manner of the assembly and disassembly operations of the lenses of the eyeglasses.

Advantageously, the first shaped edge 240 of the inlet opening 24 of the first body 2 is counter-shaped with respect to the second shaped edge 420 of the head 42 of the connection screw 4, in a manner such that the connection screw 4 is found in alignment position only when the first and the second shaped edges 240 and 420 are in coinciding angular position (being superimposed on each other on a plane orthogonal to the extension axis X).

In particular, the first and the second shaped edges 240 and 420 have non-circular shape.

Advantageously, the first narrowing section 241 of the first shaped edge 240 comprises at least one first point of minimum width, which is placed at a smaller distance from the screwing axis Y with respect to all the other points of the first shaped edge 240, and at which the inlet opening 24 has a first minimum width Lmin1 (measured transverse to the extension axis X).

Advantageously, the second narrowing section 421 of the second shaped edge 420 comprises at least one second point of minimum width, which is placed at a smaller distance from the screwing axis Y with respect to all the other points of the second shaped edge 420, and at which the head 42 has a second minimum width Lmin2 (measured transverse to the extension axis X).

Advantageously, the first shaped edge 240 of the inlet opening 24 of the first body 2 is provided with at least one first widening section 242 which is placed at a greater distance from the extension axis X with respect to the first narrowing section 241. In particular, at the first narrowing section 241, the width of the inlet opening 24 is smaller than its width at the first widening section 242.

More in detail, the first widening section 242 of the first shaped edge 240 comprises at least one first point of maximum width, which is placed at a greater distance from the screwing axis Y with respect to all the other points of the first shaped edge 240, and at which the inlet opening 24 has a first maximum width Lm1 (measured transverse to the extension axis X).

Advantageously the second shaped edge 420 of the head 42 of the connection screw 4 is provided with at least one second widening section 422, which is placed at a greater distance from the screwing axis Y with respect to the second narrowing section 421. In particular, at the second narrowing section 421, the width of the head 42 is smaller than its width at the second widening section 422.

More in detail, the second widening section 422 of the second shaped edge 420 comprises at least one second point of maximum width, which is placed at a greater distance from the screwing axis Y with respect to all the other points of the second shaped edge 420, and at which the head 42 has a second maximum width Lm2 (measured transverse to the screwing axis Y).

Advantageously, in the alignment position the second widening section 422 of the second shaped edge 420 is angularly aligned with the first widening section 242 of the first shaped edge 240 in order to allow the passage of the head 42 of the connection screw 4 through the inlet opening 24 of the first body 2.

In the misalignment position, the second widening section 422 of the second shaped edge 420 is placed in front of the interference shoulder 231 of the internal chamber 230, in a manner such that, following an axial movement of the connection screw 4 towards the inlet opening 24, the head 42 of the connection screw 2 abuts (at the widening section 422) against the interference shoulder 231 of the internal chamber 230, hence preventing the exit of the head 42 from the inlet opening 24 and hence the extraction of the connection screw 4 from the through hole 23 of the first body 2.

More in detail, in the aforesaid misalignment position, at least one portion of the second widening section 422 is not contained within the opening defined by the first shaped edge 240.

Suitably, the first shaped edge 240 (and correspondingly the second shaped edge 420) can comprise one or more first narrowing sections 241 (and correspondingly one or more second narrowing sections 421) defining a corresponding number of alignment positions for the connection screw 4.

Advantageously, in accordance with the preferred embodiment, the first and the second narrowing section 241, 421 have substantially rectilinear shape.

Preferably, the first widening section 242 and the second widening section 422 have substantially curved shape.

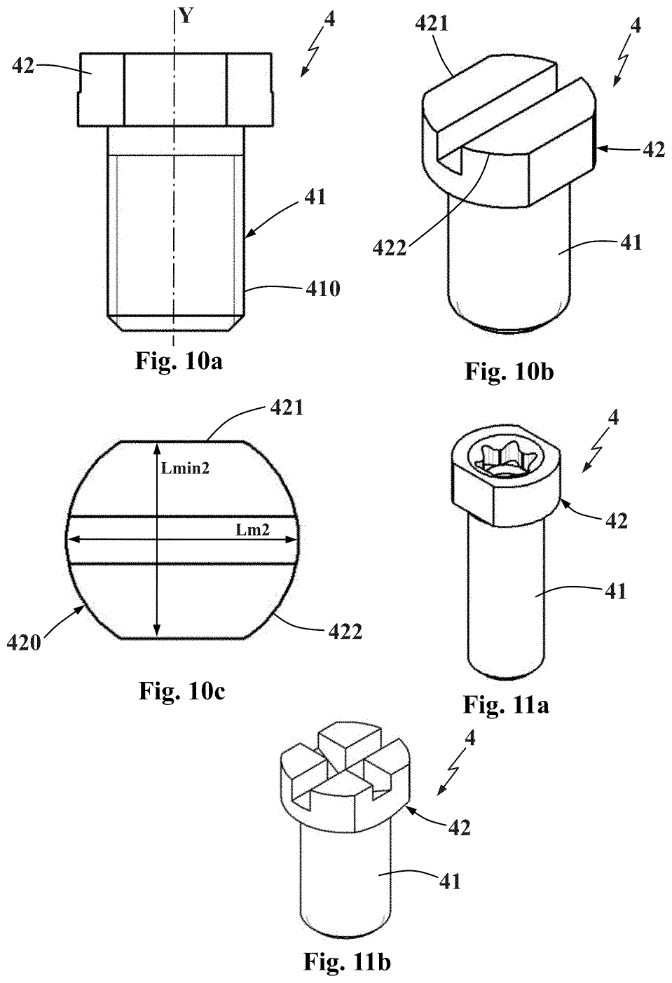

Advantageously, in accordance with the embodiments illustrated in the enclosed FIGS. 10a-b-c and 11a-b, the first shaped edge 240 of the inlet opening 24 of the first body 2 comprises two first narrowing sections 241 placed in diametrically opposite position, and the second shaped edge 420 of the head 42 of the connection screw 4 comprises two second narrowing sections 421, also placed in diametrically opposite position.

Advantageously, the first shaped edge 240 comprises two first widening sections 242 placed to connect the two first narrowing sections 241, and the second shaped edge 420 comprises two second widening sections 422 placed to connect the two second narrowing sections 421.

Preferably, the internal chamber 230 is provided with two interference shoulders 231, placed in diametrically opposite position along the corresponding two first narrowing sections 241.

Of course, without departing from the protective scope of the present patent, the shaped edges 240, 420 can have any shape (for example any one non-circular shape) adapted to define the narrowing sections 241, 421 and the widening sections 242, 422. In particular, the shaped edges 240, 420 can be axially symmetric (as in the examples of the enclosed figures) or asymmetric. In addition, the shaped edges 240, 420 can have shape with linear sections (e.g. with polygonal shape) or with curved lines (e.g. with lobe or elliptical shape), or with rectilinear and curved sections (as in the example of the enclosed figures). Suitably, in accordance with non-illustrated embodiment variants, the shaped edges 240, 420 can have one or more cavities.

Advantageously, the internal chamber 230 of the first body 2 (which houses the head 42 of the connection screw 4) comprises an annular surface 230′ (formed by a section of the internal surface 23′ of the first body 2) placed around the extension axis X, preferably coaxially with the latter.

Advantageously, the annular surface 230 is made as an undercut, both with respect to the inlet opening 24 and to the outlet opening 25, in particular at 360° according to its extension around the extension axis X.

Suitably, the internal chamber 230 has width LI (cut transverse to the extension axis X) greater than the first maximum width Lm1 at the inlet opening 24 and greater than the diameter D of the outlet opening 25.

In particular, the internal chamber 230 is obtained by means of an annular recess made on the internal surface 23′ of the first body 2 (e.g. by means of boring), therefore defining the annular surface 230 of the internal chamber 230 as a recess with respect to the edges of the inlet 24 and outlet 25 openings.

Suitably, the internal chamber 230 is extended, along the extension axis X, between a first annular wall 26′, on which the inlet opening 24 is made, and a second annular wall 26″, on which the outlet opening 25 is made. In particular, such annular walls 26′, 26″ lie on corresponding transverse planes with respect to the extension axis X. Advantageously, the interference shoulder 231 is obtained as a widened section of the first annular wall 26′.

Suitably, the interference shoulder 231 is extended substantially orthogonal with respect to the extension axis X.

Preferably, the width LI of the internal chamber 230 is greater than or equal to (and preferably greater than) the second maximum width Lm2 of the head 42 of the connection screw 4, and the length of the internal chamber 230 (according to the extension axis X) is greater than or equal to the thickness of the head (according to the screwing axis Y), in order to allow the head 42 to be housed in the internal chamber 230 itself.

Advantageously, when the stem 41 of the connection screw 4 is screwed with the threaded hole 33 of the second body 3, the head 42 of the connection screw 4 abuts against the second annular wall 26″ of the internal chamber 230 in order to retain the first body 2 with the second body 3.

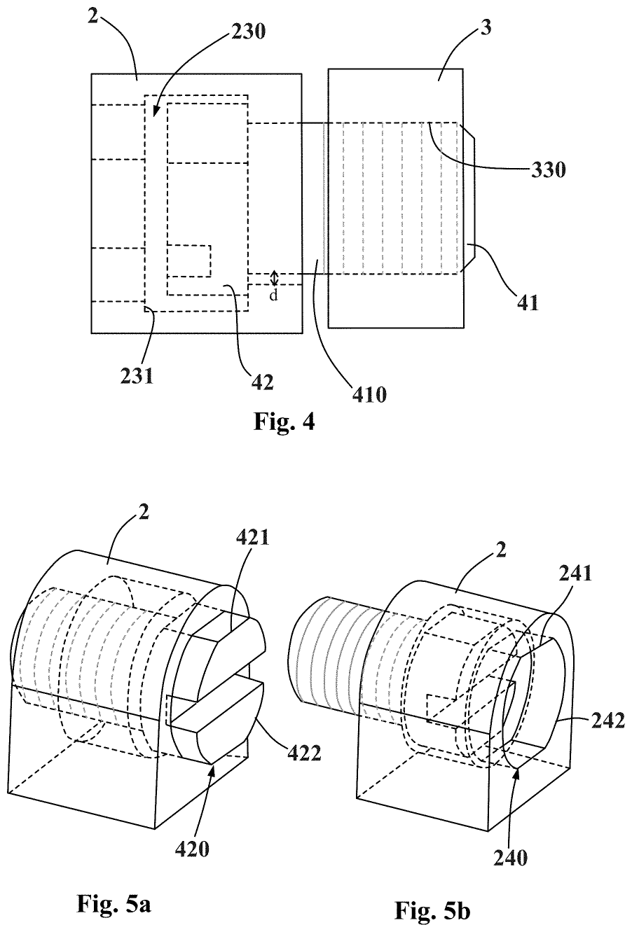

Preferably, with reference to FIG. 4, the stem 41 of the connection screw 4 has substantially circular shape and has diameter Dg smaller than the width of the outlet opening 25, in a manner such that the stem 41 is inserted in the outlet opening 25 with a given radial misalignment clearance d.

Such radial misalignment clearance d allows the stem 41 to be moved transversely, according to a direction substantially orthogonal to the screwing axis Y, of the outlet opening 25, causing a misalignment of the head 42 of the connection screw 4 with respect to the inlet opening 24 of the first body 2, as discussed in detail hereinbelow. Advantageously, the aforesaid radial misalignment clearance d has dimension comprised between several hundredths of a millimeter and several tenths of a millimeter.

Suitably, also the internal chamber 230 houses the head 42 of the connection screw 4 with radial clearance (the width LI of the internal chamber 230 being greater than the second maximum width Lm2 of the head 42).

During use (i.e. when the connection element 1 is applied to the rim 100 of the eyeglasses), the two parts 101, 102 of the rim 100 are subjected to transverse stresses, which tend to misalign the two parts 101, 102 with respect to the annular extension of the rim 100 itself.

Following the aforesaid misalignment clearance d of the stem 41 of the connection screw 42 in the outlet opening 25 of the first body 2, the aforesaid transverse stresses cause a misalignment between the first body 2 and the second body 3 of the connection element 1, and hence a consequent misalignment of the stem 41 of the connection screw 4 with respect to the outlet opening 25. This causes a corresponding misalignment of the head 42 of the connection screw 4 with respect to the inlet opening 24 of the first body 2, which further prevents the passage of the head 42 through the inlet opening 24 and hence prevents the undesired extraction of the connection screw 4 (in misalignment position) from the first body 2.

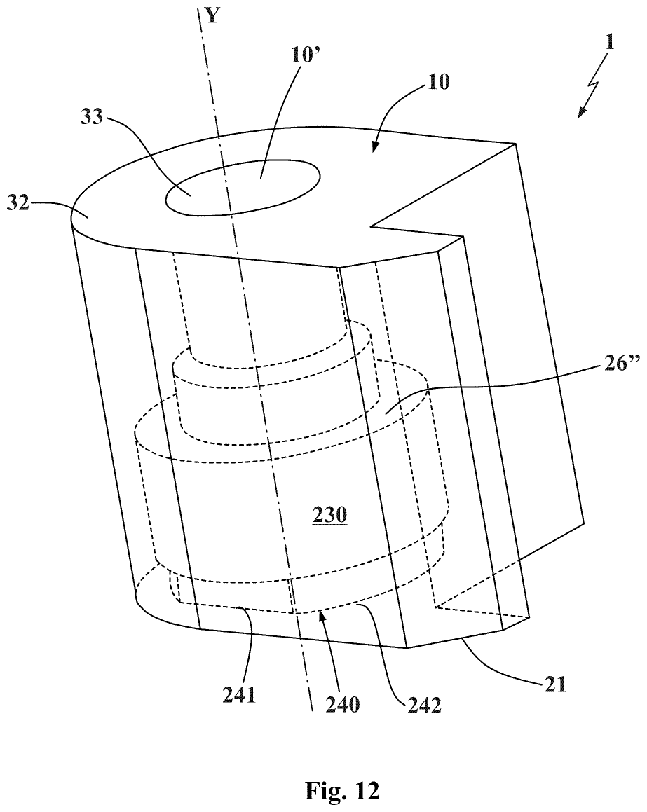

Advantageously, the first and the second bodies 2, 3 are initially made in a single semifinished body 10, an example of this illustrated in FIG. 12 (from which in particular the embodiment of FIGS. 2-9 can be made) and another example is illustrated in FIGS. 13c and 13d (from which in particular the embodiment variant of FIGS. 13a and 13b can be made).

More in detail, such semifinished body 10 is extended, according to the extension axis X, between the first external end 21 and the second external end 32, and is provided with a hole 10′ of which a first section is defined by the (future) through hole 23 and a second subsequent section is defined by the (future) threaded hole 33. In accordance with the example of FIG. 12, the hole 10′ is extended in a through manner between the inlet opening 24 of the first external end 21 and the second opening 320 of the second external end 32. In accordance with the example of FIGS. 13c and 13d, the hole 10′ is blind, extended for example starting from the inlet opening 24 up to an internal terminal wall.

Suitably, the first section of the hole 10′ (which will correspond to the through hole 23) is already provided with the above-described internal chamber 230.

The semifinished body 10 is intended to be transversely cut in a manner such to obtain the first body 2 and the second body 3.

Advantageously, the above-described connection element 1 is attained starting from a shaped section (preferably metallic), which defines the external shape of the semifinished body 10 (and hence of the bodies 2, 3 of the connection element 1).

A first milling machining is made on the shaped section, in order to create the hole 10′, preferably through, as well as a boring machining, in order to make the internal chamber 230.

Advantageously, the boring machining is made spaced from the first external end 21, in particular between a first height Q1 and a second height Q2, both interposed between the inlet opening 24 and the second opening 320.

In addition, between the inlet opening 24 and the first height Q1, at least one broaching machining is made, in order to make the first shaped edge 240 of the inlet opening 24.

The semifinished body 10 is thus transversely cut as indicated above in order to obtain the first body 2 and the second body 3.

Preferably, as described more in detail hereinbelow in the discussion of the connection process, object of the present invention, the semifinished body 10 (according to a particular embodiment of the process) is intended to be fixed to the rim 100 of the frame before being transversely cut, and only subsequently are both the rim 100 (which is thus separated into the first part 101 and into the second part 102) and the semifinished body 10 (which is thus separated into the first body 2 and into the second body 3) simultaneously cut.

In accordance with a different embodiment solution (such as, in particular, for the embodiment of FIG. 1c), the first body 2 and the second body 3 are separately made (i.e. without starting from a single semifinished body), possibly also with different technologies, and are respectively fixed to the first and to the second part 101, 102 of the rim 100 (previously cut) by means of two separate fixing operations, preferably two welding operations. In particular, with reference to the example of FIG. 1c, the second body 3 is fixed, preferably in a single body, with one of the articulation elements of the hinge 203, and the first body 2 is connected to the second body 3 by means of the connection screw 4 and is suitably housed in a suitable seat of the articulation element to which the second body 3 is fixed.

Also forming the present invention is a process for connecting two parts 101, 102 of eyeglasses by means of a connection element 1 of the type described up to now and regarding which the reference numbers will be maintained for the sake of description simplicity.

The process according to the invention comprises a fixing step, in which the first body 2 is fixed to a first part 101 of eyeglasses and the second body 3 is fixed to a second part 102 of eyeglasses.

In accordance with the embodiment illustrated in the figures, the first body 2 is fixed to the first end part 101 of the rim 100 of the frame 200, and the second body 3 is fixed to the second end part 102 of the rim 100 itself.

Advantageously, the fixing step is attained by means of welding (for example the first and the second bodies 2, 3 being made of metallic material).

In accordance with embodiment variants not illustrated in the enclosed figures the first and the second bodies 2, 3 of the connection element 1 can be fixed to two parts 101, 102 of eyeglasses by means of different fixing means, such as for example screws, rivets or by means of gluing.

According to the invention, the process also comprises a step of inserting the connection screw 4 in the through hole 23 of the first body 2, illustrated in the enclosed FIGS. 16a, 16b and preferably in the threaded hole 33 of the second body 3 (as illustrated in the enclosed FIG. 16c).

The process also comprises a tightening step, illustrated in FIG. 16d, in which the threaded portion 410 of the stem 41 of the connection screw 4 is screwed in the threaded hole 33 until the head 42 of the connection screw 4 acts in abutment against the first body 2 in order to mechanically constrain the first body 2 to the second body 3.

In accordance with the idea underlying the present invention, during the insertion step, the head 42 of the connection screw 4 is rotated around the screwing axis Y up to an alignment position, in which the second narrowing section 421 of the head 42 is angularly aligned with the first narrowing section 241 of the inlet opening 24 of the first body 2 and the second shaped edge 420 of the head 42 is contained in the opening of the inlet opening 24.

In the alignment position, the head 42 of the connection screw 4 is inserted in the inlet opening 24, up to bringing the head 42 completely within the internal chamber 230 of the first body 2, in particular beyond the interference shoulder 231.

Then, the connection screw 4 is made to rotate around the screwing axis Y in order to place it in a misalignment position, in which the second narrowing section 421 of the head 42 is angular offset with respect to the first narrowing section 241 of the inlet opening 24 and the interference shoulder 231 is interposed between the head 42 and the first external end 21 of the first body 2 and is susceptible to receive in abutment the head 42 of the connection screw 4 in order to prevent the head 42 from exiting from the through hole 23 through the inlet opening 24.

Suitably, the step of fixing the bodies 2, 3 of the connection element 1 to the parts 101, 102 of the eyeglasses can be executed before or after the steps of inserting and tightening the connection screw 4, according to the specific embodiments, regarding which two particular examples will be described hereinbelow.

In accordance with a first embodiment of the connection process, the step of fixing the two bodies 2, 3 of the connection element 1 to the eyeglasses is attained before the step of inserting and tightening the connection screw 4.

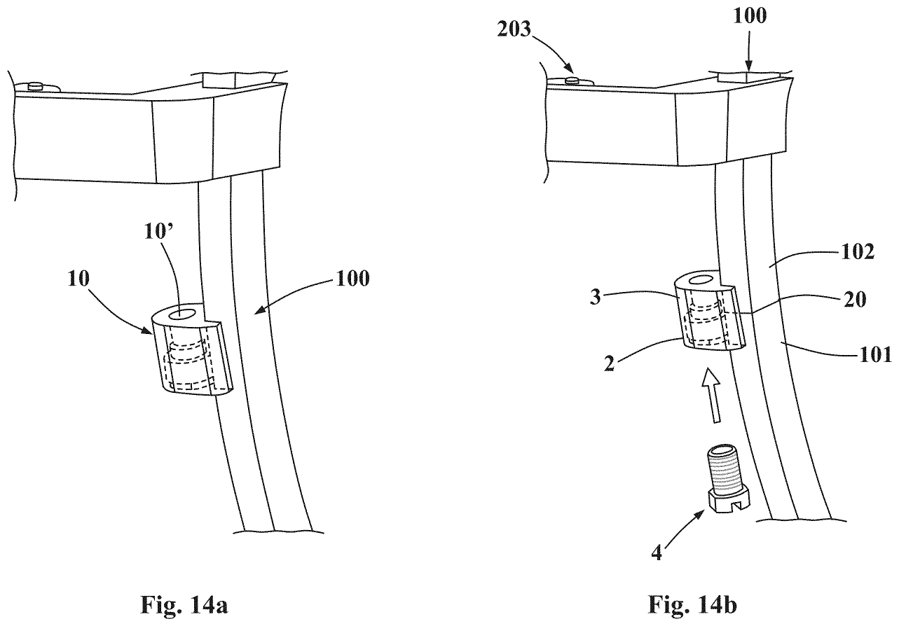

With reference to the enclosed FIGS. 14a and 14b, according to such first embodiment, in the fixing step the semifinished body 10 (from which the first and the second body 2, 3 are attained) is fixed to a rim 100 of the frame (still whole), for example by means of welding. Preferably, the welding of the semifinished body 10 to the rim of the frame 100 is attained for a length substantially equal to the extension of the same semifinished body.

Subsequently, the semifinished body 10 and the rim 100 (fixed to each other) are cut, by means of a cut 20 transverse to the extension axis X and executed between the internal chamber 230 and the second external end 32, separating the semifinished body 10 in the first body 2 and in the second body 3 and separating the rim 100 in the first part 101 and in the second part 102 fixed, respectively, to the first body 2 and to the second body 3.

Advantageously, the cut 20 is made between the through hole 23 and the threaded hole 33.

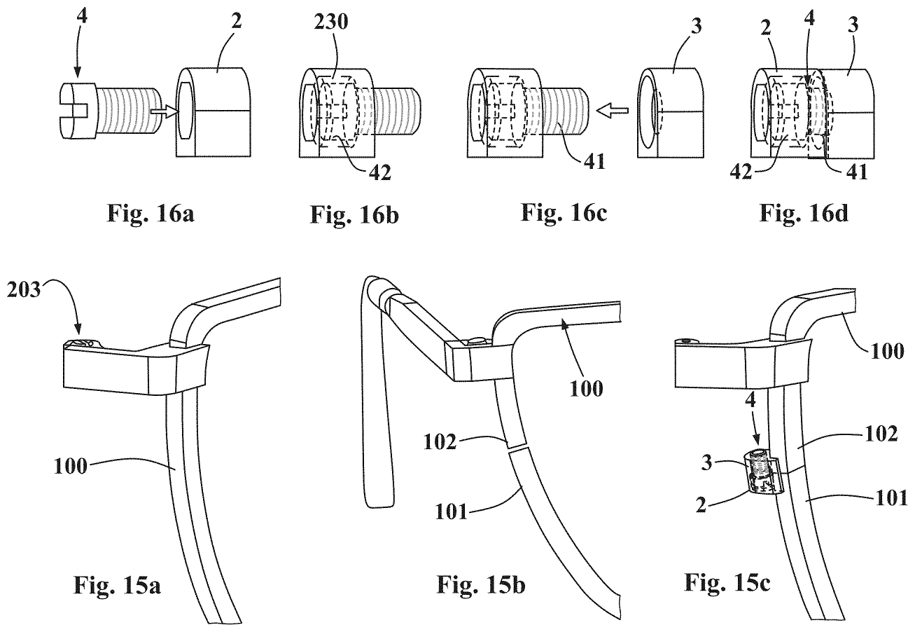

Subsequently, the step is attained for inserting the connection screw 4 in the through hole 23 of the first body, as well as the step for tightening by means of screwing of the stem 41 of the connection screw 4 with the threaded hole 33 of the second body 3. In accordance with a second embodiment, illustrated in the enclosed FIGS. 15a-c, the semifinished body 10 and the rim 100 are cut before executing the fixing step (or are made already separated at the start, as in particular in the embodiment of FIG. 1c).

In accordance with such second embodiment, the cutting step provides for only the cutting of the rim 100 of the frame, in order to separate the first (end) part 101 and the second (end) part 102 of the rim 100 itself.

In particular, before the fixing step, also the step of inserting the connection screw 4 and the tightening step are executed, in order to obtain the connection element 1 thus assembled.

Subsequently, the fixing is attained of the connection element 1, already assembled, to the two distinct parts 101, 102 of the rim 100.

Advantageously the fixing step comprises a first and a second fixing stage, in which, in the first fixing stage the first body 2 is fixed to the first end part 101 of the rim 100, and in which in the second fixing stage the second body 3 is fixed to the second end part 102 of the rim 100. The two fixing stages must be intended not in time sequence, since it is possible to first attain the second fixing stage and subsequently the first fixing stage.

Of course, without departing from the protective scope of the present invention, it is also possible to execute first the step of fixing the first and second bodies 2, 3 that are separated, and subsequently bring them close in order to carry out the insertion and fixing step.

Advantageously, following the tightening step and the fixing step, the first and the second parts 101, 102 of the rim 100, fixed to each other by means of the connection element 1, are subjected to transverse stresses. Due to the misalignment clearance d between the stem 41 of the connection screw 4 and the outlet opening 25 of the first body 2, the aforesaid transverse stresses place the second body 3 misaligned with respect to the first body 2, placing the head 42 of the connection screw 4 radially misaligned with respect to the inlet opening 24 of the misalignment clearance d.

The two parts of eyeglasses thus fixed by means of the aforesaid connection element 1 can in turn be disassembled by means of a disassembly process. Advantageously, the aforesaid disassembly process comprises a step of disengaging the threaded portion 410 of the stem 41 of the connection screw 4 from the threaded hole 33 of the second body 3, and a step of spacing, along the extension axis X of the first body 2, from the second body 3.

Following the disengagement step, the connection screw 4 is placed in the misalignment position so as to prevent the exit of the head 42 of the connection screw 4 from the outlet opening 24 of the first body 2 and therefore prevent the undesired extraction of the connection screw 4 itself.

The connection element thus conceived therefore attains the pre-established objects. The contents of the Italian patent application number 102020000022552, from which this application claims priority, are incorporated herein by reference.

1. A connection element for connecting two parts of eyeglasses, said connection element comprising:
a first body (2), which is intended to be fixed to a first part (101) of eyeglasses, is extended along an extension axis (X) between a first external end (21) and a first internal end (22), and is provided with a through hole (23) extended between an inlet opening (24) made on said first external end (21) and an outlet opening (25) made on said first internal end (22) and having a diameter smaller than said inlet opening (24);
a second body (3), which is intended to be fixed to a second part (102) of said eyeglasses, is extended along said extension axis (X) between a second internal end (31), which is directed towards the first internal end (22) of said first body (2), and an opposite second external end (32), and is provided with a threaded hole (33) extended starting from said second internal end (22);
a connection screw (4) inserted, at least partially, in the through hole (23) of said first body (2) and in the threaded hole (33) of said second body (3) in order to mechanically constrain said first body (2) to said second body (3);
said connection screw (4) comprising:
a stem (41) inserted in said through hole (23) and in said threaded hole (33), longitudinally extended along a screwing axis (Y) and provided with at least one threaded portion (410) engaged via screwing in the threaded hole (33) of said second body (3);
a head (42) fixed to said stem (41), which has width greater than said stem (41) and greater than said outlet opening (24), and acts in abutment against said first body (2) in order to maintain said first body (2) constrained to said second body (3);
wherein:
the through hole (23) of said first body (2) comprises an internal chamber (230) which is placed as a connection between said inlet opening (24) and said outlet opening (25), is extended at least partly as an undercut with respect to said inlet opening (24), and houses the head (42) of said connection screw (4);
said inlet opening (24) is provided with a first shaped edge (240), which defines an opening of said inlet opening (24) and is provided with at least one first narrowing section (241); along said first narrowing section (241), said internal chamber (230) being provided with at least one interference shoulder (231) directed towards the first internal end (22) of said first body (2);
the head (42) of said connection screw (4) is provided with a second shaped edge (420), which is provided with at least one second narrowing section (421);
wherein said connection screw (4) is movable, by means of rotation around said screwing axis (Y), between:
at least one alignment position, in which the second narrowing section (421) of said head (42) is angularly aligned with the first narrowing section (241) of said inlet opening (24) and the second shaped edge (420) of said head (42) is contained within the opening of said inlet opening (24), in order to allow the passage of said head (42) through said inlet opening (24), and
at least one misalignment position, in which the second narrowing section (421) of said head (42) is angularly offset with respect to the first narrowing section (241) of said inlet opening (24) and said interference shoulder (231) is interposed between said head (24) and the first external end (21) of said first body (2) and is susceptible to receive in abutment said head (42) in order to prevent said head (42) from exiting from said through hole (23) through said inlet opening (24).

2. The connection element of claim 1, wherein the first shaped edge (240) of the inlet opening (24) of said first body (2) is counter-shaped with respect to the second shaped edge (420) of the head (42) of said connection screw (4).

3. The connection element of claim 1, wherein said first narrowing section (241) and said second narrowing section (421) have substantially rectilinear shape.

4. The connection element of claim 1, wherein the first shaped edge (240) of the inlet opening (24) of said first body (2) is provided with at least one first widening section (242) which is placed at a greater distance from said extension axis (X) with respect to said first narrowing section (241);
wherein the second shaped edge (420) of the head (42) of said connection screw (4) is provided with at least one second widening section (422) which is placed at a greater distance from said screwing axis (Y) with respect to said second narrowing section (421);
wherein, in said alignment position the second widening section (422) of the second shaped edge (420) of said head (42) is angularly aligned with the first widening section (242) of the first shaped edge (240) of said inlet opening (24), and in said misalignment position the second widening section (422) of the second shaped edge (420) of said head (42) is placed in front of the interference shoulder (231) of said internal chamber (230).

5. The connection element of claim 4, wherein said first widening section (242) and said second widening section (422) have substantially curved shape.

6. The connection element of claim 1, wherein the first shaped edge (240) of said inlet opening (24) comprises two said first narrowing sections (241) placed in diametrically opposite position, and the second shaped edge (420) of said head (42) comprises two said second narrowing sections (421) placed in diametrically opposite position.

7. The connection element of claim 1, wherein said internal chamber (230) comprises an annular surface placed around said extension axis (X) and made as an undercut.

8. The connection element of claim 1, wherein the stem (41) of said connection screw (4) has diameter smaller than the width of said outlet opening (25), in which said stem (41) is inserted with a given radial misalignment clearance (d).

9. A process for connecting two parts of eyeglasses by means of the connection element of claim 1, said process comprising:
a fixing step, wherein said first body (2) is fixed to a first part (101) of eyeglasses and said second body (3) is fixed to a second part (102) of said eyeglasses;
a step of inserting said connection screw (4) in the through hole (23) of said first body (2);
a tightening step, wherein the threaded portion (410) of the stem (41) of said connection screw (4) is screwed into said threaded hole (33) until the head (42) of said connection screw (4) acts in abutment against said first body (2);
wherein, in said insertion step:
the head (42) of said connection screw (4) is rotated around said screwing axis (Y) up to an alignment position, in which the second narrowing section (421) of said head (42) is angularly aligned with the first narrowing section (241) of the inlet opening (24) of said first body (2) and the second shaped edge (420) of said head (42) is contained in the opening of said inlet opening (24);
in said alignment position, the head (42) of said connection screw (4) is inserted in said inlet opening (24), up to bringing said head (42) completely within the internal chamber (230) of said first body (2);
said head (42), placed in said internal chamber (230), is made to rotate around said screwing axis (Y) in order to place said connection screw (4) in a misalignment position, in which the second narrowing section (421) of said head (42) is angularly offset with respect to the first narrowing section (241) of said inlet opening (24) and said interference shoulder (231) is interposed between said head (42) and the first external end (21) of said first body (2) and is susceptible of receiving in abutment said head (42) in order to prevent said head (42) from exiting from said through hole (23) through said inlet opening (24).

10. The process of claim 9, employed for fixing together two parts (101, 102) of a rim (100) of a front (200) of said eyeglasses, wherein, in said fixing step:
said first body (2) and said second body (3) are arranged joined in a single body at said internal ends (22, 31), forming a semifinished body (10) extended between said first external end (21) and said second external end (32);
said semifinished body (10) is fixed to said rim (100);
subsequently, said semifinished body (10) and said rim (100) are cut, by means of a cut transverse to said extension axis (X) and executed between said internal chamber (230) and said second external end (32), separating said semifinished body (10) into said first body (2) and said second body (3) and separating said rim (100) into said first part (101) and said second part (102) fixed, respectively, to said first body (2) and to said second body (3).

11. The process of claim 10, wherein, following said tightening step, the first part (101) and the second part (102) of said rim (100), which are fixed together by means of said connection element (1), are subjected to transverse stresses which, following the misalignment clearance (d) between the stem (42) of said connection screw (4) and the outlet opening (25) of said first body (2), position said second body (3) misaligned with said first body (3), placing the head (42) of said connection screw (4) misaligned with respect to said inlet opening (24) by a misalignment clearance (d).
